(19) United States
(12) Patent Application Publication
(10) Pub. No.: US 2026/0183693 A1
(43) Pub. Date: Jul. 2, 2026

(54) SOLID PRIMARY AMINE AND AMIDINE-BASED MATERIALS FOR ADSORPTIVE GAS SEPARATION OF CO2, WITH IMPROVED AIR, WATER AND TEMPERATURE TOLERANCE

(71) Applicant: Svante Technologies Inc., Burnaby (CA)

(72) Inventor: Yan GAO, New Westminster (CA)

(21) Appl. No.: 19/131,938

(22) PCT Filed: Nov. 22, 2023
(86) PCT No.: PCT/IB2023/061810

§ 371 Date: May 21, 2025

Related U.S. Application Data
(60) Provisional application No. 63/427,288, filed on Nov. 22, 2022.

(51) Int. Cl. B01D 53/02

(52) U.S. Cl. CPC B01D 53/02; B01D 2253/202; B01D 2257/504; B01D 2258/06

(57) ABSTRACT

Solid adsorbents based on amidine-containing aliphatic amine polymers with resistance to oxidative damage in air and water at elevated temperatures compared to the prior art is disclosed. The solid adsorbent exhibits a high porosity and reactivity for the adsorption of carbon dioxide (CO₂) from ambient air and does not require a porous substrate material such as porous silica to generate said porosity and reactivity to or with CO₂. The material is particularly useful as a CO₂ adsorbent for Direct Air Capture (DAC) applications.

### FIELD

The present invention relates to solid materials containing both primary amine and amidine groups for use as adsorbents with enhanced stability to oxygen and water for adsorptive gas separation of CO₂ from a multi-component gas mixture. More particularly, the present invention relates to primary amine/solid amidine based adsorbents without a porous support, and use in adsorptive gas separation of CO₂ from the atmosphere or from process gases containing CO₂.

### BACKGROUND

Direct air capture (DAC) is a strategy for separating and removing CO₂ directly from the atmosphere. Adsorbents required for this challenging application require a high tolerance to O₂ (20.9 vol %) and H₂O (0-3 vol %), while separating an adsorbate with a low concentration, for example, a CO₂ concentration of 0.04 vol %. For example, separating a metric tonne of CO₂ (MT CO₂) at 100% efficiency would require the processing of roughly 2 million cubic meters of air at standard temperature and pressure (STP). Such a process to capture 1 MT CO₂ would expose the adsorbent material to roughly 380 MT of O₂ at STP due to the ratio of O₂ to CO₂ in ambient air (i.e. 20.9% for O₂ at a molecular weight of 32 g/mol compared to 0.04% for CO₂ with a molecular weight of 44 g/mol). Therefore, there is a requirement for CO₂ adsorbent materials for DAC applications and other applications with different levels of CO₂ than the atmosphere but which also present an oxygen sensitivity issue for the adsorbent to be highly resistant to O₂. Furthermore, adsorbents for use in DAC should also be stable or resistant to the loss of CO₂ adsorption capacity upon exposure to H₂O as the adsorbent can be subjected to condensation of water vapour in the feed stream (especially in humid environments), and during regeneration of the adsorbent where steam is typically used, for example, in Temperature Swing Adsorption (TSA) and Temperature Vacuum Swing Adsorption (TVSA) processes. These CO₂ adsorbents are also subjected to and need to resist thermal expansions and contractions during TSA or TVSA processes which typical cycle at elevated temperatures, for example, about 50-120° C.

Commercially available Anion Exchange Resins (AER) comprising primary and/or secondary amines are widely used in water treatment applications for the removal of anions from hard water. The relatively high production volumes of these polymers for water treatment applications reduces the costs of these materials which makes the materials attractive for use as a CO₂ adsorbent for DAC applications and other CO₂ separation applications with a requirement for reduced oxidative degradation rates. Aminated celluloses, a major family of commercially available AERs contain high concentrations of hydroxyl groups which results in high rates of water adsorption. If these AERs are used in and subjected to high humidity environments, their high rate of water adsorption dramatically decreases their CO₂ adsorption capacity. In addition, water adsorbed on an adsorbent increases the energy consumption for regeneration of the adsorbent due to the high sensible heat and heat of vaporization of water.

To address these issues, porous benzylamine-based AERs were considered, in the place of aminated cellulose AERs, as an adsorbent for DAC applications due to their higher CO₂ adsorption capacity and water tolerance. However, the relatively rapid oxidative degradation rate resulting in a short lifetime and low durability is a shortcoming of porous benzylamine-based AERs. Also, the key performance parameters vary greatly when using benzylamine-based adsorbents in DAC applications due to the high sensitivity and resulting variability of the CO₂ adsorption capacity as a function of temperature and humidity.

Polyallylamine and polyvinylamine are considered for use as CO₂ adsorbents due to their superior oxidative stability as compared to benzylamine-based adsorbents. However, such polymers tend to be non-porous at the operating temperatures of TSA or TVSA processes and therefore they require a solid porous support material such as, porous silica, to provide voids to increase the adsorption capacity of CO₂ for these processes.

In U.S. Pat. No. 8,715,397, ExxonMobil discloses the use of mixed nucleophilic and non-nucleophilic base liquid adsorbents for gas separation of CO₂ from a high temperature flue gas. However, these gas separation processes employ liquid amine adsorbents. Further enhancements which accelerate the kinetics of CO₂ adsorption are highly desirable as the potential for rapid CO₂ adsorption from gases in solid adsorbents is greater relative to the liquid adsorbents referenced above.

Therefore, there remains a need to further improve the air (or oxidative), water and temperature resistance of a solid CO₂ adsorbent while maintaining a desired CO₂ adsorption capacity which overcomes the shortcomings of the prior art. Embodiments of the present invention are described below.

### SUMMARY

In a broad aspect, a solid material for use as adsorbents for adsorbing a first component in a multi-component gas mixture, the solid material is described comprising an allylamine or a vinylamine monomer polymerized in combination with amidine functional groups.

In another broad aspect, an adsorptive process for separating a multi-component gas, the multi-component gas comprising at least a first component and a second component, the process comprising:
(a) providing a contactor comprising a solid material comprising an allylamine or a vinylamine monomer polymerized in combination with amidine functional groups as an adsorbent;
(b) admitting the multi-component gas as a feed stream into the contactor, adsorbing at least a portion of the first component on and/or in the adsorbent, producing a first product stream depleted in the first component relative to the feed stream, and recovering the first product stream from the contactor, and
(c) desorbing at least a portion of the first component sorbed in and/or onto the adsorbent, producing a second product stream enriched in the first component relative to the feed stream, and recovering the second product stream from the contactor.

### BRIEF DESCRIPTION OF THE DRAWINGS

FIG. 1 illustrates a structural chemical synthesis pathway for a reaction employed to synthesize an embodiment of the invention, AER1;

FIG. 2 illustrates a structural chemical synthesis pathway for a reaction employed to synthesize an embodiment of the invention, AER2;

FIG. 3a illustrates an FTIR spectrum from 600 to 3600 cm⁻¹ of the embodiment in accordance to FIG. 1 (AER1);

FIG. 3b illustrates an FTIR spectrum from 600 to 3600 cm⁻¹ of the embodiment in accordance to FIG. 2 (AER2) comparing the material's spectral lines before hydrolysis treatment, after hydrolysis treatment, and with or after heat treatment;

FIG. 4a illustrates a TGA (Thermogravimetric Analysis) illustrating the kinetics of CO₂ adsorption, comparing AER1 (initiated with V-50™) to a commercial benzylamine adsorbent;

FIG. 4b illustrates a TGA (Thermogravimetric Analysis) illustrating the kinetics of CO₂ adsorption, comparing AER2 (initiated with V-50™) to a commercial benzylamine adsorbent;

FIG. 5 illustrates the CO₂ adsorption capacity of AER1 and a commercial benzylamine adsorbent, after 2 minutes of adsorption and 30 minutes of adsorption, at 15 vol % CO₂ and 50° C.;

FIG. 6 illustrates the CO₂ adsorption capacity of AER1 and a commercial benzylamine adsorbent over 10 temperature cycles between 50° C. and 110° C., at 15 vol % CO₂;

FIG. 7 illustrates the CO₂ adsorption capacity of AER1, AER2, and a commercial benzylamine adsorbent over a temperature range of 40° C. to 110° C., at 15 vol % CO₂;

FIG. 8a are plots illustrating CO₂ adsorption capacities of the AER1 adsorbent and a commercial benzylamine adsorbent, over 10 temperature cycles between 50° C. to 110° C., and 15 vol % CO₂. The plots are representative of the cyclic oxidative stability of the adsorbents;

FIG. 8b are plots illustrating the CO₂ adsorption capacities of the AER2 adsorbent before heat treatment, the AER2 adsorbent after heat treatment at 180° C. for 16 hours, and a commercial benzylamine adsorbent, over 10 temperature cycles between 50° C. to 110° C., and 15 vol % CO₂. The plots are representative of the cyclic oxidative stability of the adsorbents;

FIG. 9a is a column chart illustrating the adsorption capacities of H₂O and CO₂ of the AER1 adsorbent and a commercial benzylamine adsorbent at different temperatures and relative humidities with 400 ppm CO₂;

FIG. 9b is a column chart illustrating the adsorption capacities of H₂O and CO₂ of the AER2 adsorbent without heat treatment, the AER2 adsorbent with various heat treatment conditions, and a commercial benzylamine adsorbent, at 30° C., 80% RH, with 400 ppm CO₂;

FIG. 10a illustrates a TGA plots of the AER1 adsorbent and a commercial benzylamine adsorbent of wet air adsorption at a temperature of 10° C. with 65% RH over time;

FIG. 10b illustrates a TGA plots of the AER1 adsorbent and a commercial benzylamine adsorbent of wet air adsorption at a temperature of 30° C. with 30% RH over time;

FIG. 10c illustrates a TGA plots of the AER1 adsorbent, the AER2 adsorbent material with heat treatment, and a commercial benzylamine adsorbent of wet air adsorption at a temperature of 30° C. with 80% RH over time;

FIG. 11a is a SEM analysis at 300× magnification of AER1, showing agglomerate sizes between ˜1 μm and 200 μm;

FIG. 11b is a SEM analysis at 3000× magnification of AER1, showing agglomerate sizes between ˜5 and 20 μm;

FIG. 11c is a SEM analysis at 10,000× magnification of AER1, showing an agglomerate size of >5 μm and individual grain sizes of the invention material in the range of 0.2-0.5 μm;

FIG. 11d is a SEM analysis at 3,000× magnification of AER1, showing a surface morphology of one agglomerate with individual grain sizes of 0.2-0.5 μm evident;

FIG. 12a is a SEM image of the AER2 laminate after hydrolysis treatment and before heat treatment;

FIG. 12b is a SEM image of the AER2 laminate after heat treatment at 180° C. for 24 hours; and

FIG. 13 is a process flow diagram of an embodiment of the present invention, illustrating an adsorptive process for separating a first component from a multi-component gas using a contactor with AER1 or AER2 adsorbents.

### DESCRIPTION

Novel solid amidine materials based upon amidine and primary amine chemistry for use as solid adsorbents with high oxygen stability, high CO₂ adsorption capacity, high porosity, and high reactivity to CO₂, are disclosed herein. Solid amidine based materials are suitable for use as adsorbents for the separation of CO₂ from the atmosphere, for example, direct air capture (DAC) applications or other CO₂ separation applications, would benefit from reduced oxidative degradation rates. Advantages of mixing bases in liquid form, are described in an ExxonMobil Research and Engineering Company patent (U.S. Pat. No. 8,715,397), include higher basicity non-nucleophilic amidine which can promote the formation of ammonium carbamate by accepting proton generated interaction of the nucleophilic amine with CO₂ to form the ammonium counter-cation. In other published investigations, non-nucleophilic amidine is more oxidatively stable than nucleophilic bases, which decreases the concentration of nucleophilic amine in the adsorbent, the labile functional groups for oxidative degradation in DAC processes. As a result, the adsorbents with non-nucleophilic bases provide a greater oxygen tolerance relative to anion exchange resins (AERs) with nucleophilic bases.

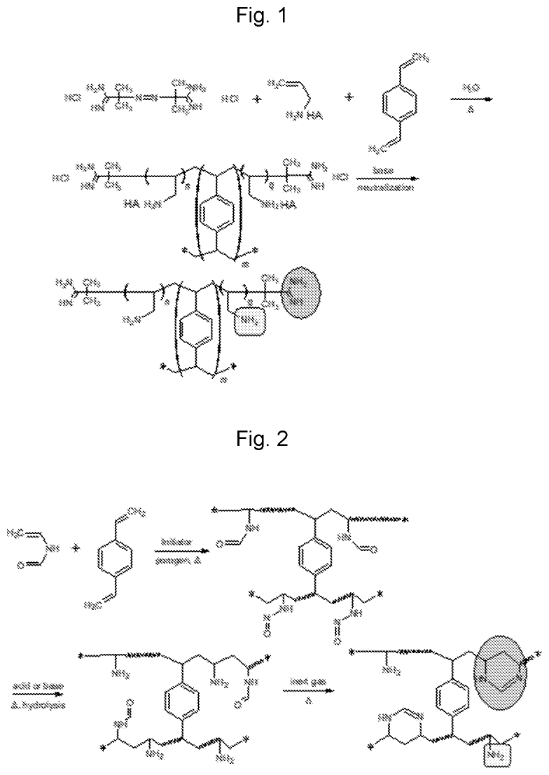

In an embodiment, an amidine based material can comprise an allylamine polymerized in combination with one or more amidine functional groups (described herein as “AER1”). In one aspect, the amidine based material with allylamine (AER1) can be a solid. In another embodiment, the amidine based material with allylamine (AER1) can be configured and/or formed as a solid for use as an adsorbent (also referred herein as a “solid adsorbent” or “solid polymeric adsorbent”), for adsorptive gas separation of a component, for example, carbon dioxide (CO₂) from a multi-component gas stream, for example, air. In embodiments, the AER1 material and the AER1 solid polymeric adsorbent can be configured to adsorb carbon dioxide (CO₂) with a porosity (pore size between one nanometer and one millimeter) to allow diffusion of CO₂ in less than a minute and/or a particle size or an agglomerate of less than one millimeter, and/or can be selectively adsorbent to CO₂. In embodiments, the AER1 material and the AER1 solid polymeric adsorbent can be porous to CO₂ and/or configured without a porous supporting substrate material. In other aspects, the AER1 material and the AER1 solid polymeric adsorbent can be configured in the form of a structured adsorbent, a structured CO₂ adsorbent, or into macroscopic adsorbent structures, such as, sheets and passages. In an embodiment, non-nucleophilic amidine structures can be introduced with amidine-containing initiators to form AER1 material and an AER1 solid polymeric adsorbent. The synthesis pathway for AER1 is illustrated in FIG. 1.

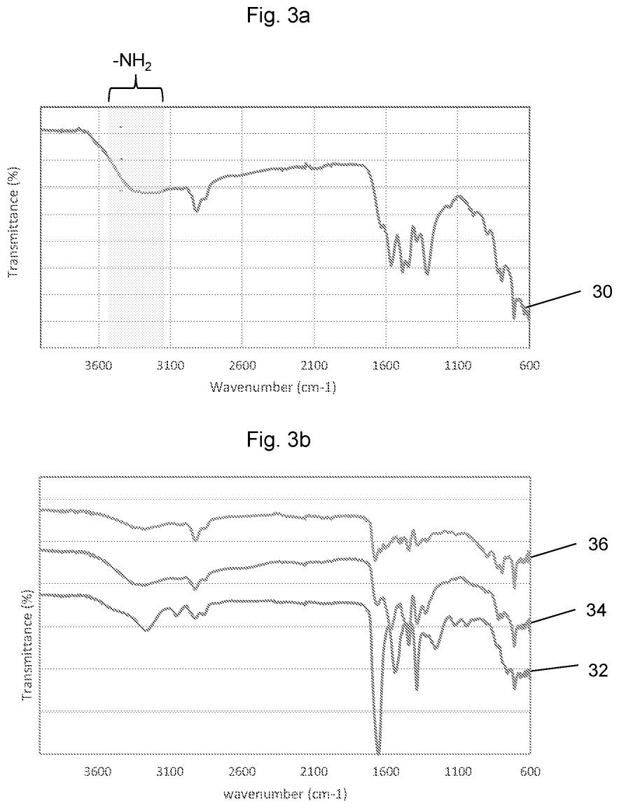

In another embodiment, an amidine based material can comprise a vinylamine monomer polymerized in combination with one or more amidine functional groups (described herein as “AER2”). In embodiments, the amidine based material with vinylamine (AER2) can be a solid. In embodiments, the amidine based material with vinylamine (AER2) can be configured and/or formed as a solid for use as an adsorbent (also referred herein as a “solid adsorbent”, or “solid polymeric adsorbent”), for adsorptive gas separation of a component, for example, carbon dioxide (CO₂) from a multi-component gas stream, for example, air. In aspects, the AER2 material and the AER2 solid polymeric adsorbent can be configured to adsorb carbon dioxide (CO₂) and/or can be selectively adsorbent to CO₂. In an embodiment, the AER2 material and the AER2 solid polymeric adsorbent can be porous to CO₂ and/or configured without a porous supporting substrate material. In embodiments, the AER2 material and the AER2 solid polymeric adsorbent can be configured in a form of a structured adsorbent, a structured CO₂ adsorbent, a laminate (for example, a layered structure) or into macroscopic adsorbent structures, such as laminated sheets, beads and/or passages in a solid material. In an embodiment, the AER2 material and/or the AER2 solid polymeric adsorbent can be produced by including at least one post-treatment step (treatment of the material after synthesis) of vinylamine and amide containing polymers, where the post-treatment step includes one or more of a hydrolysis treatment and/or a heat treatment. The synthesis pathway for AER2 is illustrated in FIG. 2.

In embodiments, each of the AER1 material, AER1 solid polymeric adsorbent, AER2 material, and AER2 solid polymeric adsorbent, can have an adsorption capacity for CO₂, where the adsorption capacity for CO₂ can be equal to or greater than 35 milliliters (ml) or cubic centimeters (cc) of CO₂ at STP at a temperature of 50° C., and a concentration of CO₂ of 15% per gram of the material, solid material, or solid polymeric adsorbent. In embodiments, each of the AER1 material, AER1 solid polymeric adsorbent, AER2 material, and AER2 solid polymeric adsorbent, can have a selectivity for CO₂ of equal to or greater than about 100 to 1 over nitrogen (N₂) or oxygen (O2). In another embodiment, each of the AER1 material, AER1 solid polymeric adsorbent, AER2 material and AER2 solid polymeric adsorbent, can have an oxidative degradation rate measured as a loss in CO₂ adsorption capacity over a period in time or loss in CO₂ adsorption capacity over a number of adsorption and desorption cycles, where the oxidative degradation rate is equal to or less than about half of an oxidative degradation rate of a benzylamine ion exchange resin (the terms “resin” and “adsorbent” may be used interchangeably herein) when the materials or adsorbents are subjected to substantially the same conditions in the same physical configuration, for example, exposure to or in air and at a temperature of equal to or greater than about 100° C. in the same adsorption apparatus.

The chemical structures of AER1 and AER2 demonstrate a desired porosity to CO₂, and a greater tolerance to water, oxygen, and/or elevated temperatures relative to prior art AERs without non-nucleophilic amidine promoter organic functional groups, such as, commercially available benzylamine-based adsorbents. The porosity of the AER1 and AER2 to CO₂ can beneficially reduce the need for a porous support structure when configuring the AER1 and AER2 materials as an adsorbent. AER1 and AER2 materials and adsorbents offers a greater reliability or resistance to oxidative degradation, which enables their use across a wider range of environmental or atmospheric operating conditions, including, for example, at higher ambient temperatures and/or at higher humidities.

In embodiments, the AER1 or AER1 material, was synthesized, including polymerization. In embodiments, the synthesis method was initiated by V-50™ initiator from Fujifilm Wako Chemicals from Richmond, Virginia), for example, 2,2′-azobis (2-methylpropionamidine) dihydrochloride (an amidine compound) and from starting precursor monomers such as allylamine hydrochloride (a primary amine) and subsequent reaction with divinyl benzene (DVB). Non-nucleophilic amidine structures were introduced with amidine-containing initiators during synthesis.

In embodiments, the AER2 or AER2 material, can be synthesized from N-vinylformamide, divinylbenzene, with Vazo-88™ from SigmaAldrichSigma Aldrich (1,1-azobis (cyclohexanecarbonitrile)) as an initiator, and a solvent, for example, N, N-dimethylformamide, N,N-dimethylacetamide, N-methylpyrrolidone, with V-50™ as an initiator. Other amidine-containing initiators, such as VA-044™ and VA-057™, also from Fujifilm Wako Chemicals, can be used to generate similar amidine adsorbent materials with a desired CO₂ adsorption capacity. Other azo initiators can be used instead of Vazo-88™. Non-nucleophilic amidine structures can be introduced with amidine-containing initiators by post-treatment of vinylamine and amide containing polymers.

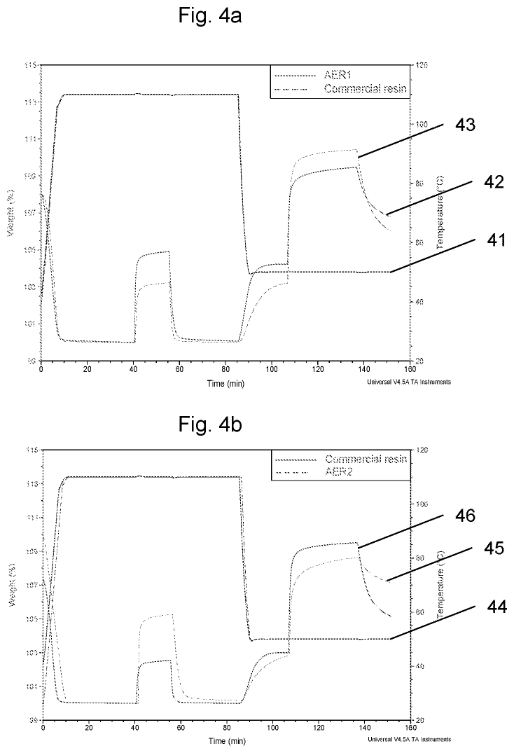

FIGS. 3a and 3b are Fourier Transform Infrared Spectroscopy (FTIR spectra) plots of AER1 and AER2 respectively. As shown in FIG. 3a, the x-axis represents wavenumber in cm⁻¹ while the y-axis represents transmittance in percentage, and an AER1 plot 30. The AER1 plot 30 shows the AER1 material with C═N bonds at 1650-1900 cm⁻¹ and NH2 groups at 3150-3500 cm⁻¹. This provides evidence that embodiments of the present invention incorporated the amidine and amine functionality as illustrated in the process sequence and synthesis pathways as illustrated in FIG. 1.

As shown in FIG. 3b, the x-axis represents wavenumber in cm⁻¹ while the y-axis represents transmittance in percentage, and shows a before hydrolysis plot 32 of the AER2 material, an after hydrolysis plot 34 of the AER2 material, and an after heat treatment plot 36 of the AER2 material, where the heat treatment was performed at a temperature of 180° C. for 16 hours. The C═O or C═N bond and the NH2 infrared absorption is significantly reduced in the hydrolyzed and heat-treated materials.

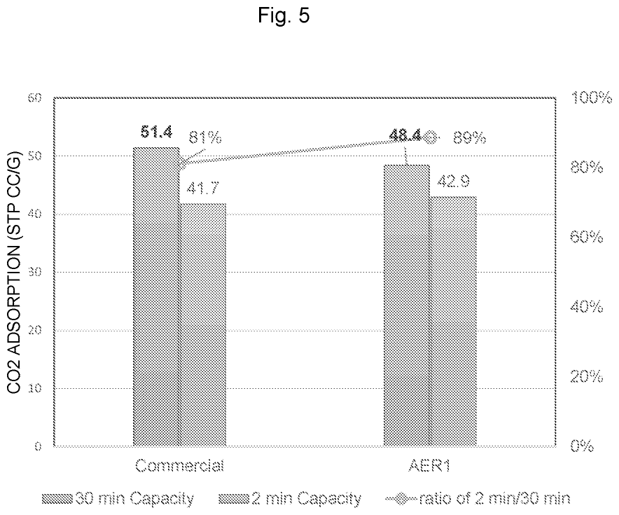

FIG. 4a illustrates a TGA (Thermogravimetric Analysis) showing a TGA curve or plot of CO₂ adsorption (at 110° C. for 15 min and 50° C. for 30 min with 15% CO₂ balanced with helium) of the AER1 material with V-50™ initiator in comparison to a commercial benzylamine adsorbent. A temperature plot 41 shows the temperature in degrees Celsius, a AER1 plot 42 shows adsorption of CO₂ by AER1 as a weight %, and a benzylamine plot 43 shows adsorption of CO₂ by the benzylamine adsorbent as a weight %. The initial adsorption at 50° C. (between 80-110 minutes) was caused by residual CO₂ left-over in the TGA furnace cleared by the flow of helium during the desorption step. This led to an initially lower CO₂ adsorption at 50° C. and higher adsorption when the residual CO₂ was removed from the material.

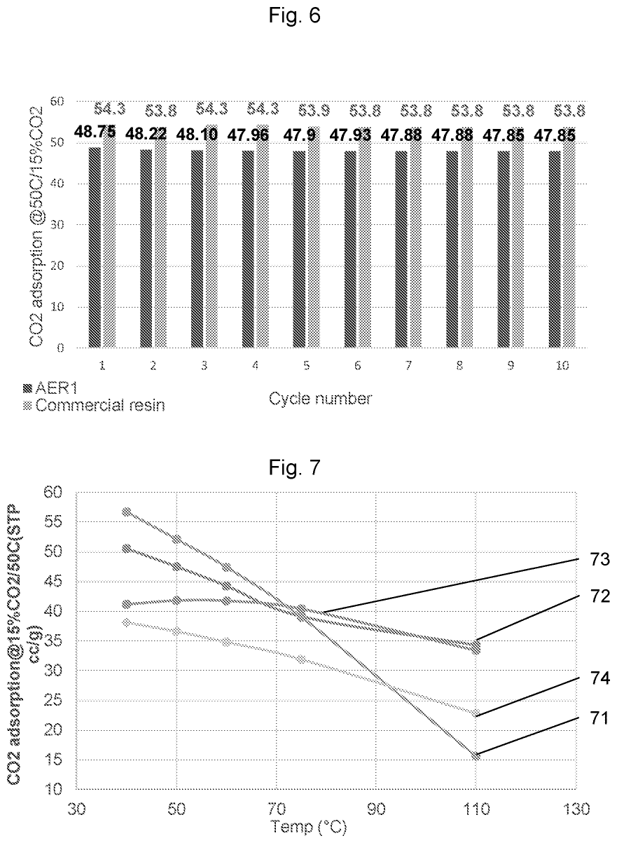

FIG. 5 is a chart which shows a comparison of AER1's CO₂ adsorption capacity relative to a commercial benzylamine adsorbent measured at 50° C. and 110° C., 15% CO₂, of CO₂ adsorption and desorption with helium gas. As shown, the left x-axis is the CO₂ adsorption capacity in cubic centimeters per gram (cc/g) of material or adsorbent, while the right x-axis is the ratio between a 2 minute (min) CO₂ adsorption capacity and a 30 minute CO₂ adsorption capacity in percentage (%). The CO₂ adsorption capacities are shown as columns, while the ratio between the 2 minute and 30 minute CO₂ adsorption capacities are shown as small circles connected with a line.

An adsorbent with a higher CO₂ adsorption capacity advantageously benefits an adsorptive process by shortening the time for adsorption and desorption, or cycle time, of an adsorptive process, resulting in increasing a productivity of the adsorption process and/or by increasing a total absorbent capacity of a given adsorptive gas separator and adsorbent system for a given footprint or capital cost. Referring to FIG. 5, although AER1 shows a slightly lower CO₂ adsorption capacity at 30 minutes relative to a commercial benzylamine adsorbent, the 2 minute CO₂ adsorption capacity of the AER1 is higher than the commercial benzylamine adsorbent, which can result in a shorter adsorption and desorption cycle time and increased productivity and/or throughput for an adsorptive gas separation process, an adsorptive gas separator, and/or an adsorption system.

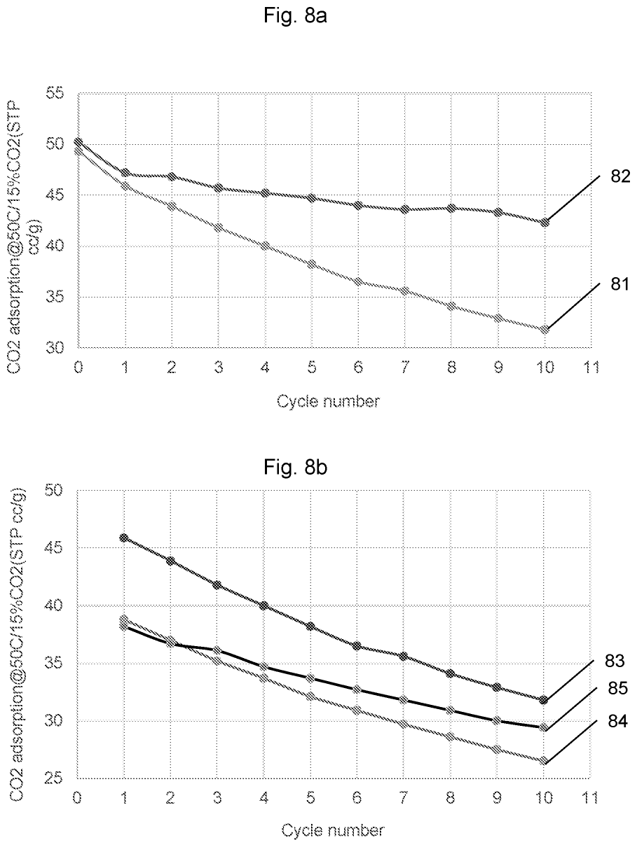

Typically, the desorption cycles of TSA or VTSA processes with organic chemicals as sorbents normally occur at temperature below 110° C. FIG. 6 shows AER1 adsorbents to be thermally and temperature stable over several cyclic cycles, where adsorption occurs at 50° C. and desorption at 110° C. The thermal stability of the AER1 is almost identical to that of the commercial benzylamine adsorbent.

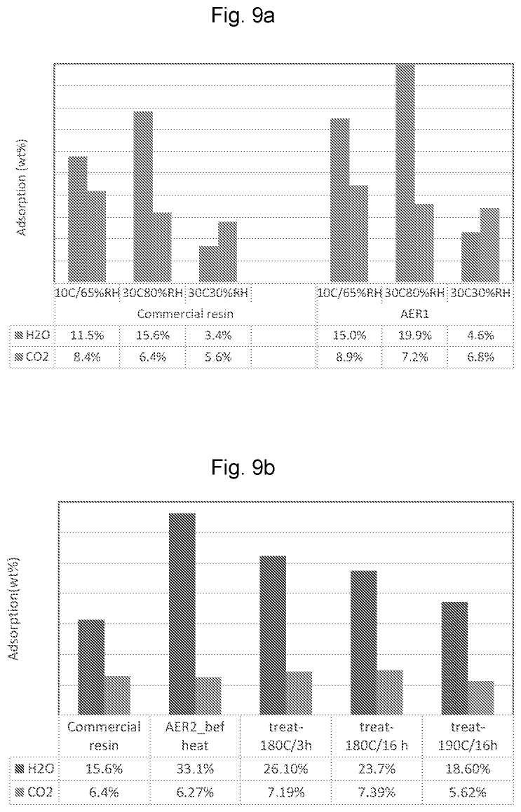

FIG. 7 illustrates plots showing CO₂ adsorption capacities of AER1, AER2, and a commercial benzylamine adsorbent over a temperature range of 40° C. to 110° C., at 15 vol % CO₂, and showing changes in CO₂ adsorption capacity as a function of temperature. The CO₂ adsorption capacities of the commercial benzylamine adsorbent is shown as plot 71, AER1 is shown as plot 72, AER2 before after-treatment is shown as plot 73, and AER2 with heat treatment at 180° C. is shown as plot 74.

As shown, both AER1 and AER2 adsorbents demonstrate a reduced rate of decrease in CO₂ adsorption capacity as a function of temperature. For the adsorptive gas separation of 400 ppm CO₂ from air in DAC applications, strong binding of CO₂ with an adsorbent is desired. Furthermore, an adsorbent with a reduced temperature sensitivity is preferable, in order to enable an adsorbent to be used in applications and/or locations subject to wide operating parameters, including for example, wide environmental or atmospheric conditions encountered at a location or different locations, during the day, nights, summer and winters. Embodiments of the AER1 and AER2 materials show a reduced CO₂ adsorption capacity sensitivity as a function of temperature and can beneficially deliver stable CO₂ adsorption capacity without or with fewer process parameter adjustments.

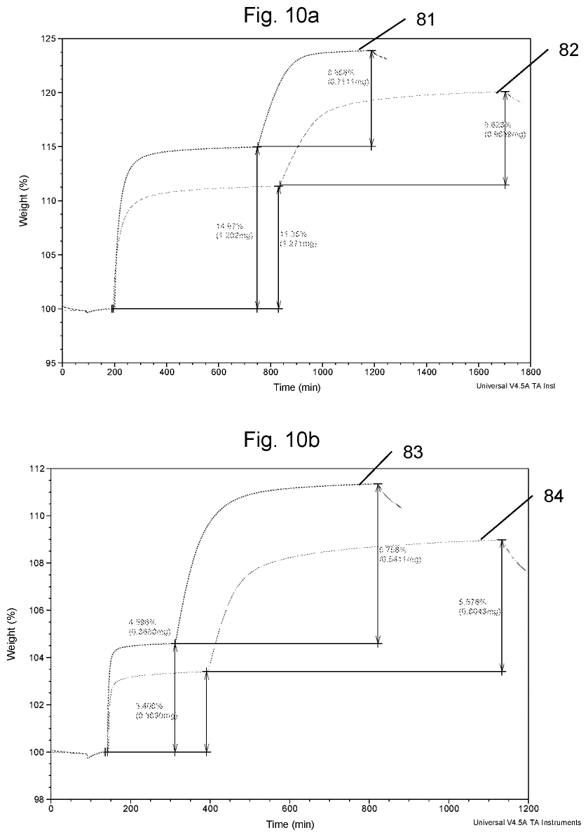

FIG. 8a are plots illustrating the CO₂ adsorption capacities of AER1 (plot 82), and a commercial benzylamine adsorbent (plot 81) over 10 temperature cycles, where the temperature cycles between 50° C. to 110° C., and 15 vol % CO₂, which is representative of cyclic oxidative stability under accelerated conditions, for example, exposure of the materials to air at 110° C. for 1 hour (h) per cycle and for 10 cycles. The AER1 material shows an increase in oxidative stability relative to the commercial benzylamine-based adsorbent as indicated by the small degradation slope of AER1 relative to the degradation slope of the commercial benzylamine adsorbent.

FIG. 8b are plots illustrating the CO₂ adsorption capacities of the commercial benzylamine adsorbent (plot 83), AER2 before heat treatment (plot 84), and AER2 after heat treatment at 180° C. for 16 hours (a plot 85) over 10 temperature cycles where the temperature cycles between 50° C. to 110° C., and 15 vol % CO₂, which illustrates the cyclic oxidative stability under accelerated conditions. The oxidative stability of the AER2 material before heat treatment or plot 84, is similar to the commercial benzylamine adsorbent or plot 83, as shown by the slope of their respective plots. However, the AER2 material after heat treatment, demonstrates a significantly improved cyclic oxidative stability as shown by the slope of plot 85.

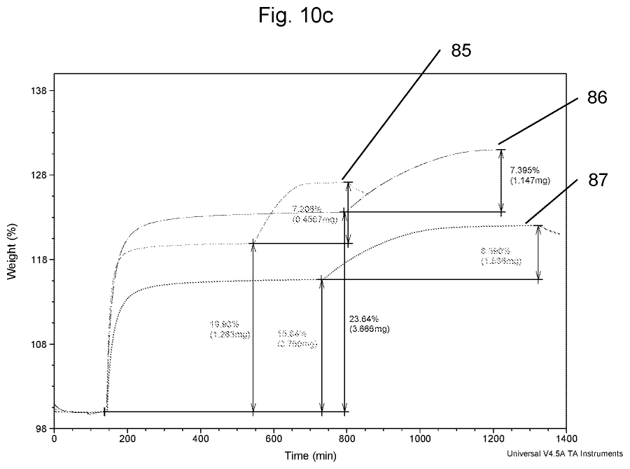

FIG. 9a is a column chart illustrating the adsorption capacity of H₂O and CO₂ of AER1 material and the commercial benzylamine adsorbent under different temperatures and relative humidity (RH) conditions. The CO₂ capture performance of the AER1 material was characterized with a TGA Q5000™ (by TA instruments New Castle, Delaware) experiment under specific temperature and humidity conditions, by initially exposing samples of the dried adsorbent material to moisture at near saturation levels (RH about 90-100%), and then directing air containing 400 ppm CO₂ at the adsorbent material to measure the CO₂ adsorption capacity. As illustrated in FIG. 9a, H₂O and CO₂ adsorption capacities of embodiments of AER1 were compared to the commercial benzylamine adsorbent at 30° C. and 30% (RH). The AER1 material adsorbed slightly greater amounts of H₂O and comparable amounts of CO₂ relative to the commercial benzylamine resin at 10° C., 65% RH, as well as 13-21% greater CO₂ adsorption capacity at 30° C., under 80% RH and 30% RH relative to commercial benzylamine resin.

FIG. 9b is a column chart illustrating adsorption capacity of H₂O and CO₂ of the commercial benzylamine adsorbent, the AER2 material without or before heat treatment, and the AER2 material with various heat treatment conditions, at 30° C., 80% RH, and 400 ppm CO₂. Before heat-treatment, AER2 adsorbed greater amounts of H₂O and comparable amounts of CO₂ relative to the commercial benzylamine adsorbent. After heat-treatment, the adsorption of H₂O decreased while the adsorption of CO₂ increased. Further heat-treatment decreased adsorption of both H₂O and CO₂. However, the heat treatment at a relatively high temperature reduced the CO₂ adsorption capacity (to 4.65 wt %) of the material. A post heat-treatment at 180° C. for 16 h resulted in a H₂O adsorption capacity of about 23 wt % for the AER2 material with heat-treatment compared to 33 wt % for the AER2 material without heat-treatment, and a CO₂ adsorption capacity of 7 wt % for the AER2 material with heat-treatment compared to 6 wt % for the AER2 material without heat-treatment.

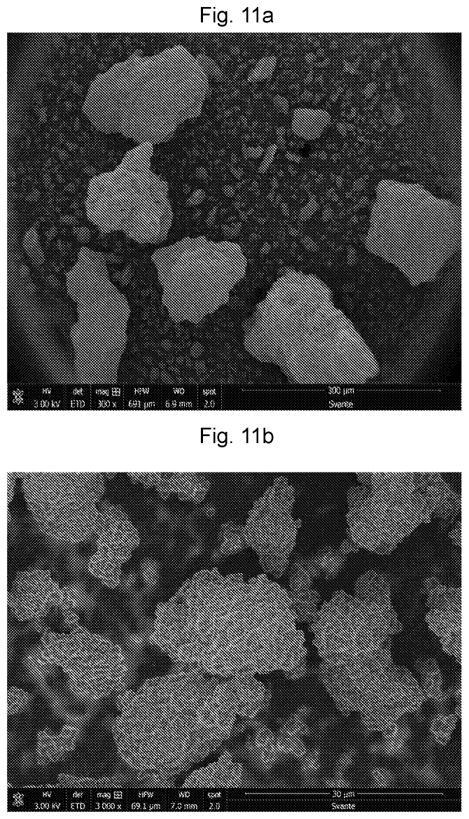

FIG. 10a shows TGA plots of wet air adsorption for AER1 compared to the commercial benzylamine adsorbent at a temperature of 10° C. with 65% Relative Humidity (RH). A TGA AER1 plot 81 shows a steeper slope of the adsorption curve (at the second step between 700-1200 minutes, which is representative of CO₂ adsorption) relative to a TGA benzylamine plot 82. The steeper slope indicates that the adsorption kinetics of the AER1 is more rapid or faster relative to the commercial benzylamine adsorbent under conditions of 10° C. and 65% RH. Faster kinetics of adsorption enables an adsorptive gas separator to use a lower quantity of adsorbents resulting in reducing the size and cost of the gas separator.

FIG. 10b, shows TGA plots of wet air adsorption for AER1 compared to the commercial benzylamine adsorbent at a temperature of 30° C. with 30% RH, with similar results as shown in FIG. 10a (10° C., 65% RH conditions). AER1 is shown as a TGA AER1 plot 83, and commercial benzylamine resin is shown as a TGA benzylamine plot 83.

FIG. 10c shows TGA plots of wet air adsorption of AER1 adsorbent material as TGA AER1 plot 85, and AER2 adsorbent material with heat treatment as TGA AER2 plot 86, compared to the commercial benzylamine adsorbent as TGA benzylamine plot 87 after exposure to 30° C. and 80% RH.

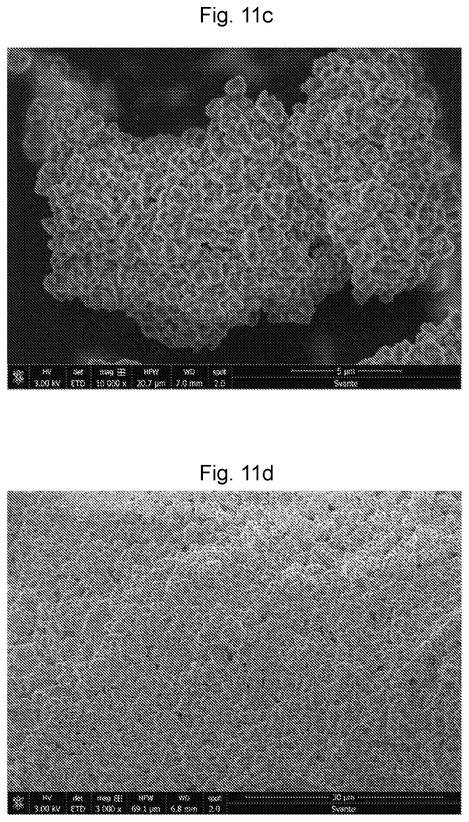

Agglomerates of various sizes of AER1 as analyzed by Scanning Electron Microscopy (SEM) under differing levels of magnification (×) are shown in FIG. 11a at 300×, FIG. 11b at 3000×, FIG. 11c at 10,000× and FIG. 11d at 3000×. The grain size of the AER1 is in the range of 0.2-0.5 μm. Accompanying Brunauer-Emmett-Teller (BET) and Mercury adsorption tests (not shown) correspond well with this SEM measured grain size. However, the CO₂ adsorption level supports a porosity or reactivity to CO₂ far in excess of the surface area of the grains as measured by N₂ (nitrogen) during the BET test. This implies that CO₂ diffuses through and reacts with and plasticizes the material while the N₂ during the BET test does not. This rather surprising result is not expected from the prior art liquid solution chemistry of amines and amidine groups. The desired performance of the solid material in terms of its CO₂ adsorption capacity is a result of this porosity and reactivity, and the use of initiators employed to generate the polymerization intrinsic to these solid adsorbents with melting points well above the operating temperatures of the processes employed for these tests, for example, less than about 150° C.

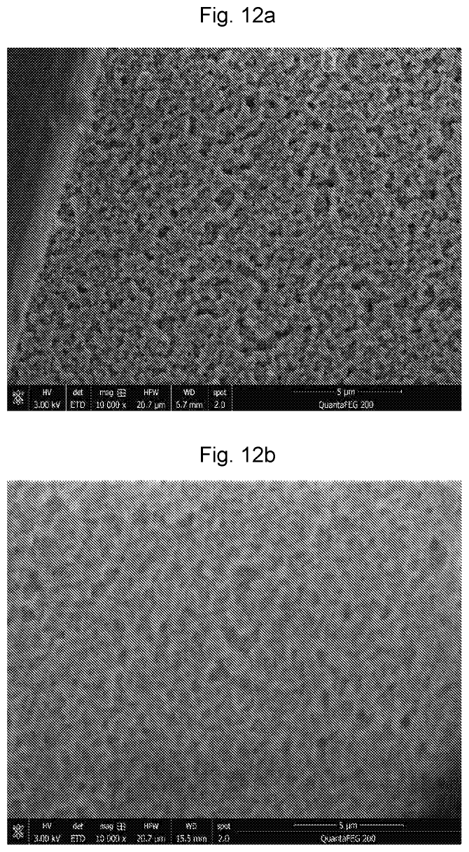

FIG. 12a shows a SEM image of AER2 material or laminate, after hydrolysis treatment and before heat treatment. FIG. 12b shows a SEM image of the AER2 material or laminate, after heat treatment at 180° C. for 24 hours. The SEMs in FIG. 12a and FIG. 12b confirmed the porous structure after hydrolysis and thermal treatment.

The amidine based materials having allylamine polymerized in combination with one or more amidine functional groups (AER1), or a vinylamine monomer polymerized in combination with amidine functional groups (AER2), configured for use as solid adsorbents disclosed herein can be used for the purpose of separating a first component, for example, carbon dioxide, from a multi-component gas stream, for example, the atmosphere, atmospheric air, or ambient air or a process gas containing CO₂. AER1 or AER2 sorbents can be used, for example, to reduce CO₂ from the atmosphere and to provide a concentrated stream of the first component, for example, CO₂, that can be further utilized for sequestration or other industrial usage.

In embodiments, an adsorptive gas separator, a gas separator and/or a contactor of the present invention can be used in an adsorptive process for separating a first component, for example, carbon dioxide from a multi-component gas stream. Embodiments of the gas separator and/or contractor can be provided where the contactor comprises the AER1 or AER2 adsorbents disclosed herein. In embodiments, the AER1 or AER2 adsorbents can be configured with a porous support. In an embodiment, the contactor can be a parallel passage contactor or a packed-bed contactor.

In an embodiment, an adsorptive process for adsorptive gas separation of a multi-component gas comprising at least a first component, for example, carbon dioxide, is provided. In embodiments, the adsorptive process can separate at least a portion of the first component from the multi-component fluid gas, for example, from the atmosphere, atmospheric air, ambient air, or air or a process gas.

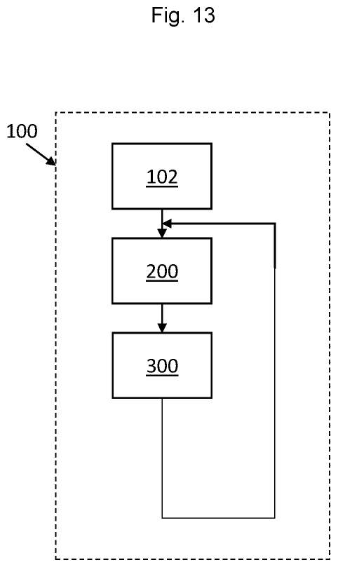

FIG. 13 illustrates an embodiment, showing an adsorptive process 100 for separation of a multi-component fluid gas or stream comprising at least a first component, for example, carbon dioxide, and a second component. The adsorptive process 100 can comprise the steps of a providing step 102, an adsorbing step 200 and a regenerating step 300, where the adsorbing step 200 and a regenerating step 300 can be repeated sequentially until adsorptive process 100 is terminated.

Providing step 102, further comprises providing a gas separator and/or contractor where the contactor comprising the AER1 or AER2 adsorbents disclosed herein. In an embodiment, the contactor can be a parallel passage contactor or a packed-bed contactor.

Adsorbing step 200, can further comprise admitting a multi-component gas or stream, for example, atmosphere, atmospheric air, ambient air, or air, or a process gas containing at least a first component (for example, carbon dioxide) and a second component (for example, nitrogen), as a feed stream into the gas separator and/or the contactor; flowing the feed stream through the contactor and contacting the feed stream with the AER1 or AER2 adsorbents; adsorbing at least a portion of the first component of the feed stream in and/or onto the AER1 or AER2 adsorbents, separating the first component from the feed stream, and forming a first product stream at least partial depleted in the first component relative to the feed stream; and recovering the first product stream from the contactor and/or gas separator. Although not specifically shown, the remaining components that are not sorbed in and/or onto the AER1 or AER2 adsorbents, for example, the second component such as nitrogen, can substantially flow through the contactor and exit the contactor and gas separator as the first product stream.

In applications and processes where the multi-component gas or feed stream desired for processing with large volumes of air, the AER1 or AER2 adsorbents offers the advantages of a high adsorption capacity for the target or first component, with a high stability and durability when exposed to water, oxygen, and hot air (for example, between about 80° C.-150° C.) relative to conventional adsorbents.

Regenerating step 300, can further comprise desorbing at least a portion of the first component sorbed in and/or onto the AER1 or AER2 adsorbents, by at least one of a temperature swing mechanism, and a partial pressure swing mechanism; forming a second product stream at least partial enriched in the first component relative to the feed stream, and recovering the second product stream from the contactor and/or gas separator.

In embodiments, regenerating step 300 can also comprise admitting a regeneration stream (such as steam) into the gas separator and/or contactor for contacting the AER1 or AER2 adsorbents as the regeneration stream flows through the contactor; desorbing the first component sorbed in and/or onto the AER1 or AER2 adsorbents; forming a second product stream at least partially enriched in the first component relative to the feed stream; and recovering the second product stream from the contactor and/or gas separator. In embodiments, heat from the regenerating stream and/or at least a portion of the regeneration stream (such as water from the steam) can sorb in and/or onto the AER1 or AER2 adsorbents, assisting in desorbing the first component sorbed in and/or onto the AER1 or AER2 adsorbents.

In FIG. 13, adsorbing step 200 and regenerating step 300 can be repeated sequentially until adsorptive process 100 is terminated.

1. A solid material for use as adsorbents for adsorbing a first component in a multi-component gas mixture, the solid material comprising an allylamine or a vinylamine monomer polymerized in combination with amidine functional groups.

2. The solid material of claim 1, wherein the solid material is porous to CO₂.

3. The solid material of claim 2, wherein the solid material is at least one of an adsorbent, configured as a structured adsorbent, and configured as a laminate, for use to adsorb CO₂.

4. The solid material of any one of claims 1 to 3, wherein the solid material is configured without an adsorbent support.

5. The solid material of any one of claims 1 to 4, wherein the solid material further comprises an adsorption capacity for CO₂, wherein the adsorption capacity for CO₂ is equal to or greater than about 40 ml of CO₂ at STP per gram of the material.

6. The material of any one of claims 1 to 5, wherein the solid material is selectively adsorbent to CO₂.

7. The solid material of any one of claims 1 to 6, wherein the solid material further comprises a selectivity for CO₂, NO₂, and O₂, wherein a ratio of a selectivity for CO₂ to one of a selectivity for NO₂ or a selectivity for O₂, is equal to or greater than about 100 to 1.

8. The solid material of any one of claims 1 to 7, wherein the solid material further comprises an oxidative degradation rate in air at a temperature of equal to or greater than about 100° C., wherein the oxidative degradation rate of the solid material is equal to or less than about half of a degradation rate of a benzylamine resin exposed to the same conditions in the same apparatus.

9. An adsorptive process for separating a multi-component gas mixture having at least a first component and a second component, the process comprising:
(a) providing a contactor comprising the solid material of any one of claims 1 to 8 as an adsorbent;
(b) admitting the multi-component gas mixture as a feed stream into the contactor, adsorbing at least a portion of the first component on and/or in the adsorbent, producing a first product stream depleted in the first component relative to the feed stream, and recovering the first product stream from the contactor, and
(c) desorbing at least a portion of the first component sorbed in and/or onto the adsorbent, producing a second product stream enriched in the first component relative to the feed stream, and recovering the second product stream from the contactor.

10. The process of claim 9, wherein the multi-component gas is an atmosphere or an atmospheric air, and the first component is carbon dioxide.
